(19) United States
(12) Patent Application Publication
(10) Pub. No.: US 2016/0163196 A1
(43) Pub. Date: Jun. 9, 2016

(54) SYSTEM AND METHOD FOR AIDING ON-STREET PARKING OCCUPANCY DETECTION FROM A MOVING DEVICE

(71) Applicant: Xerox Corporation, Norwalk, CT (US)

(72) Inventors: David Cummins, Washington, DC (US); Yao Rong Wang, Webster, NY (US); Matthew Darst, Chicago, IL (US)

(73) Assignee: Xerox Corporation

(21) Appl. No.: 14/560,033

(22) Filed: Dec. 4, 2014

(51) Int. Cl. G08G 1/14; B60Q 1/00

(52) U.S. Cl. CPC G08G 1/143; B60Q 1/00

(57) ABSTRACT

Systems and methods for aiding on-street parking occupancy detection from a moving device, such as, for example, an automotive vehicle, a bicycle, etc. An optimized route(s) can be pre-selected for scheduling the moving device from one street block to another. A display device displays where the moving device is at the time on the optimized route and selects, for example, the street block, and a recording device that records parking occupancy data. In some embodiments, a GPS module can be provided, which communicates with the recording device to assist in determining the location of the parking occupancy data.

### TECHNICAL FIELD

Embodiments are generally related to the field of parking management. Embodiments are additionally related to on-street parking occupancy detection. Embodiments are also related to the collection and analysis of parking occupancy data.

### BACKGROUND OF THE INVENTION

Meeting the parking needs of motorists requires more than simply finding a balance between supply and demand; yet the capability to efficiently allocate and manage on-street parking remains elusive, even when parking needs are significant, recurring, and known ahead of time. For instance, urban parking spaces characteristically undergo periods of widely skewed demand and utilization, with low demand and light use in some periods, often during the night, and heavy demand and use at other times.

Real-time parking occupancy detection systems are an emerging technology in the field of parking management. Some sensor companies, for example, have tried to use probabilities, essentially a “closeness rating” to determine the likelihood of parked vehicles in undemarcated environments. A system in the market for on-street parking occupancy detection involves the use of “puck-style” sensors that output a binary signal when detecting, for example, a vehicle in a parking stall. FIG. 1 illustrates an example schematic diagram of a prior art puck-style parking occupancy detection system 2 that includes the use of one more of puck-style sensors 7, 9, and 11 for on-street parking occupancy detection. As shown in the illustration of FIG. 1, a vehicle 3 is parked in a parking spot with respect to “puck-style” sensors 7, 9, 11 located on respective light poles. “Puck-style” in-ground sensors have also been implemented in some sections of several cities to provide real-time data for drivers reporting street occupancy in a city.

As an alternative to sensor-based solutions, video-based applications have also been proposed to determine parking occupancy data. In these types of systems, video cameras are deployed on-site to monitor parking spots. The captured video is processed real-time to report available parking space to drivers. FIG. 2 illustrates a schematic illustration of a prior art parking occupancy detection system 10 based on the use of video cameras. System 10 includes one or more cameras such as camera 28 and an associated monitoring or communications unit 32 positioned on, for example, a pole 30 to monitor on-site parking spaces, such as, for example, parking spaces 18, 20, 22, 24, and 26 of a parking area 12, which may be, for example, an on-street parking area (e.g., along a street block). The captured video can be processed real-time to report available parking space to, for example, drivers or parking lot management staff. The parking spaces 18, 20, 22, 24, and 26 and sample vehicles 32, 34, and 36 are shown within a field of view 16 of the camera 28.

The cost for a puck-style in-ground sensor is typically about $200 or more per sensor, plus permit and construction fees, and about $5-$10 per sensor per month for maintenance and communication. For a demarcated street, one sensor covers a single parking space. For an un-demarcated street that offers free-flow parking, 3 or more sensors may be required for each parking space (e.g., ˜20 ft.) in order to determine parking occupancy with reasonable accuracy. Video-based parking occupancy technology such as those of system 10 shown in FIG. 2 offers comparable to lower cost to sensor technology in the case of demarcated streets, but is considerably cheaper than sensor with free flow parking. Still, $200 per parking space cost is high for cities as a city could have thousands of parking spaces. Additionally, street projects may require the removal and replacement of sensors at additional costs.

A more cost effective way for obtaining on-street parking occupancy data may involve the use of cameras mounted on, for example, a trailer or on a moving vehicle. In the latter case, the parking occupancy data is collected only for the instance of time and space, and therefore can only be used as “historical” and can be combined with other data such as parking meter payment data for modeling and prediction.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for systems and methods for improved parking management.

It is another aspect of the disclosed embodiments to provide for systems and methods for on-street parking occupancy detection.

It is yet another aspect of the disclosed embodiments to provide systems and methods for the collection and analysis of parking occupancy data.

The aforementioned aspects and other objectives and advantages can now be achieved as described herein. Systems and methods are disclosed for aiding on-street parking occupancy detection from a moving device. One or more optimized routes can be pre-selected for scheduling a moving device from one location to another. A display device can be employed, which graphically displays the one optimized route(s) and a current location of the moving device with respect to the one optimized route. Additionally, a recording device can record parking occupancy data for display via the display device. Such a recording device may be or involve the use of one or more cameras, which may be located on the moving device (e.g., car, truck, bicycle etc.) and/or may be located elsewhere (e.g., standalone street surveillance cameras that communicate with the recording and/or display devices).

A GPS module can also be employed, which communicates with the recording device to assist in determining the spatial location of the parking occupancy data. The display device can graphically display a window that allows manual input of the parking occupancy data to the recording device. The parking occupancy data can be obtained by manual input (e.g., human eye surveillance) and/or automatically (e.g., one or more cameras). Additionally, a memory can be employed, which communicates with the recording device and the display device. The optimized route can be downloaded as data from a remote server to the memory and displayed via the display device.

Parking occupancy data generally includes, but is not limited to, the number of vehicles parked on a street block or block face and a time stamp specifying the time the vehicles are detected. Optionally, the occupancy data specifies the occupancy of each parking space of the street block or block face.

The disclosed approach thus offers systems and methods that will aid in on-street parking occupancy detection from a moving device. An optimized and pre-selected route for scheduling the moving device from one street block to another can be utilized. Since a typical city has hundreds of street blocks, an optimized and pre-determined route for the moving device to travel will add efficiency of data collection and avoid repetitiveness and possibly errors.

The display device displays where the moving device is at the time on the selected route and selects the street block. For example, when the moving device is at the first street block of the green route, the display device should display the street name either automatically or manually. In the automatic mode, a GPS device may be equipped with the system. Optionally, the display device also displays a window that allows manual input of the parking occupancy data of the street block.

The recording device can record the parking occupancy data. The parking occupancy data could be obtained by eye surveillance (manual input) or automatically from the parking occupancy detection device (such as a camera) on the moving device.

In one embodiment, a general procedure for using such a system can be implemented as follows. First, an operation can be implemented to optimize the route(s) for the street blocks with respect to the parking occupancy data to be collected. Next, an operation can be implemented to turn on the system that already has the optimized route(s) downloaded (e.g., downloaded from a server). Then, an operation can be implemented to position the moving device at the first street block of the optimized route(s). The display device can then display the street name either automatically or manually by touching the display device that has the map of the street block. Thereafter an operation can be implemented to take a survey of parking occupancy of the street block. Such a survey may be automatically implemented. The survey could be taken by a person, in that case the parking occupancy data of the street block will be entered manually; or automatically by an occupancy detection device such as a camera that is attached on the moving device, in that case the moving device can move through the street and occupancy data recorded automatically. The moving device can then be positioned at the next street block followed by, for example, displaying a street name and implementing a survey again, and so on

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a prior art schematic diagram of puck-style parking occupancy detection system involving the use of one more of such sensors for on-street parking occupancy detection;

FIG. 2 illustrates a schematic illustration of a prior art parking occupancy detection system based on the use of video cameras;

FIG. 3 illustrates an example screen shot of optimized and selected routes for collecting parking occupancy data, in accordance with a preferred embodiment;

FIG. 4 illustrates a system for aiding on-street parking occupancy detection from a moving vehicle, in accordance with a preferred embodiment;

FIG. 5 illustrates a method for aiding-onstreet parking occupancy detection, in accordance with an alternative embodiment;

FIG. 6 illustrates a block diagram of an example of a mobile data processing system suitable for use with one or more of the described embodiments; and

FIG. 7 illustrates a schematic view of a software system including a module, an operating system, and a user interface, in accordance with one or more of the described embodiments.

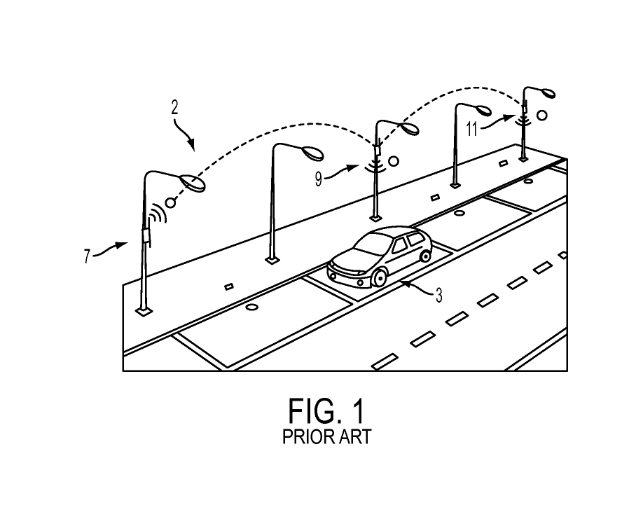

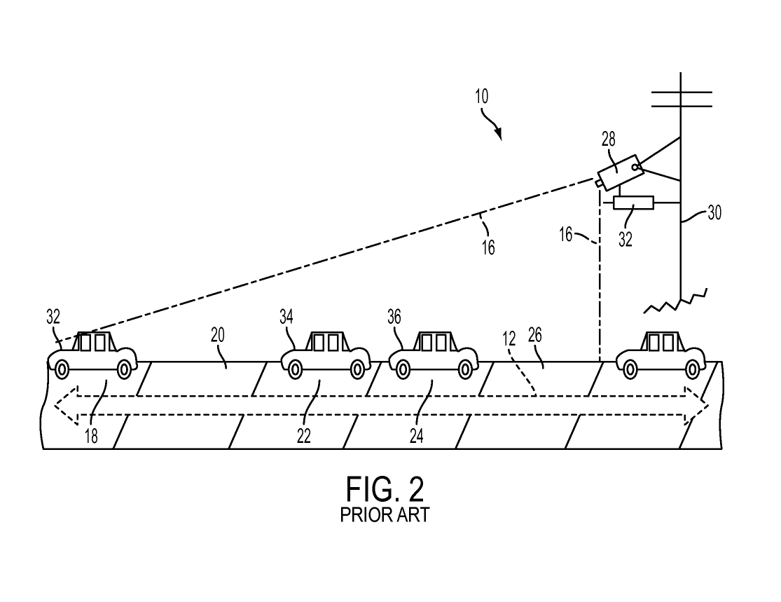

### DETAILED DESCRIPTION

The particular values and configurations discussed in these non-limiting examples can be varied and are cited merely to illustrate at least one embodiment and are not intended to limit the scope thereof.

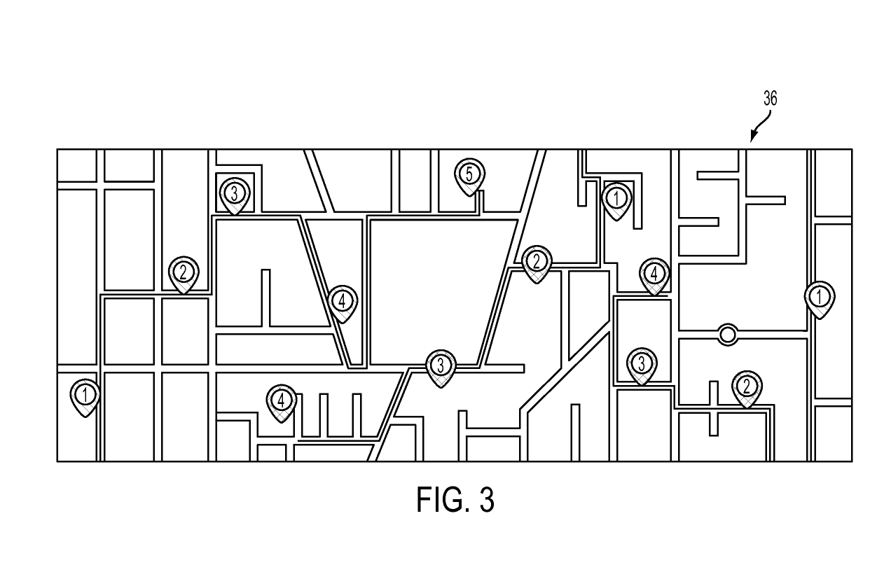

FIG. 3 illustrates an example screen shot of optimized and selected route(s) 36 for collecting parking occupancy data, in accordance with a preferred embodiment. The disclosed embodiments can aid in on-street parking occupancy detection from a moving device. Such a moving device can be, for example, a vehicle, a person or a bicycle. The system can include, for example, an optimized and pre-selected route for scheduling the moving device from one street block to another. Since a typical city has hundreds of street blocks, an optimized and pre-determined route for the moving device to travel will add efficiency of data collection and avoid repetitiveness and possibly errors. FIG. 3 thus depicts an example of the selected routes and the order of the street blocks the moving device travels through.

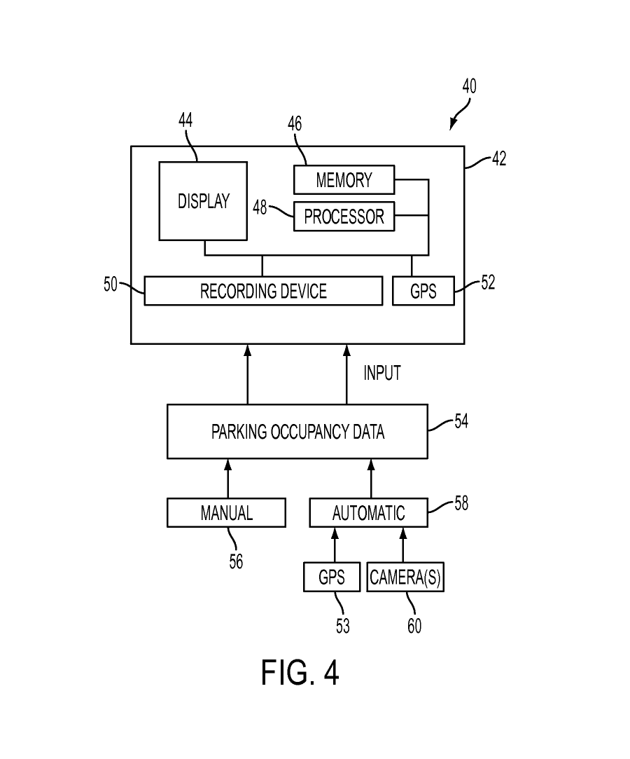

FIG. 4 illustrates a system 40 for aiding on-street parking occupancy detection from a moving vehicle, in accordance with a preferred embodiment. System 40 generally includes a display device 42 composed of, for example, a display 44, a memory 46, and a processor 48. The display device 42 in some embodiments may be positioned on the moving device. For example, in some situations, the moving device may be a vehicle and the display device 42 can be situated on or inside the vehicle to obtain information parking occupancy data as the vehicle physically drives the route 36 displayed on display 44. In other embodiments, the moving device may be, for example, a bicycle or other vehicle. The display device 42 can display where the moving device is at the time on the selected route (e.g., the optimized route 36 shown in FIG. 3) and select, for example, a particular street block shown on the route/map.

In one illustrative scenario, when the moving device is at the first street block of the green route, the display device 42 should display the street name either automatically or manually. In the automatic mode, a GPS (Global Positioning Satellite) device or module 52 may be equipped with the system 40. Optionally, the display device 42 can display a graphical window via display 44 that allows manual input of parking occupancy data regarding the street block.

A recording device 50 can record the parking occupancy data 54. Such parking occupancy data can be obtained by manual input 56 (e.g., human eye surveillance) or automatic input 58 derived from, for example, a camera 60, which may be associated with the parking occupancy detection device located on, for example, the moving device. An optional GPS module 53 may also be utilized in association with the camera 60 to obtain such occupancy data 54.

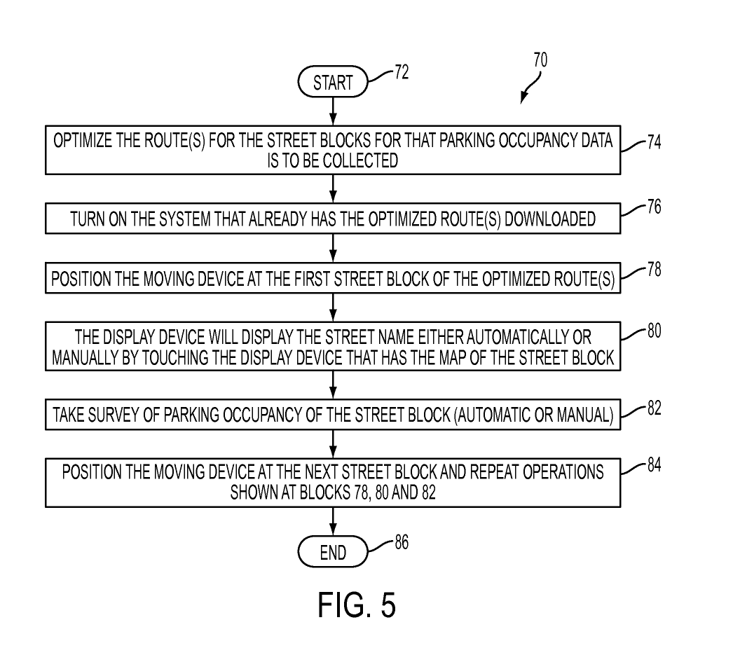

FIG. 5 illustrates a method 70 for aiding on-street parking occupancy detection, in accordance with an alternative embodiment. Method 70 can implement a procedure for implementing the system 40 shown in FIG. 4. As depicted at block 72 in FIG. 5, the process can be initiated. Thereafter, as indicated at block 74, a step or logical operation can be implemented to optimize the route(s) (e.g., route 36 shown in FIG. 3) for the street blocks for that parking occupancy data is to be collected. Then, as indicated at block 76, a step or logical operation can be implemented to turn on the system that already has the optimized route(s) downloaded.

Then, as described at block 78, a step or logical operation can be implemented to position the moving device at the first street block of the optimized route(s). The display device can then display the street name either automatically or manually by touching the display device that has the map of the street block, as shown at block 80. Next, as depicted at block 82, a step or logical operation can be provided for taking or implementing a survey of parking occupancy of the street block. Such a survey can be taken by a person, in which case the parking occupancy data of the street block will be entered manually; or automatically by an occupancy detection device such as a camera (e.g., camera 60), which may be attached to the moving device, in which case the moving device will move through the street and occupancy data will be recorded automatically. Thereafter, as shown at block 84, a step or logical operation can be implemented to position the moving device at the next street block and repeat the steps or operations of blocks 78, 80, and 82. The process can then terminate as illustrated at block 86.

The embodiments are described at least in part herein with reference to flowchart illustrations, and/or schematic/block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

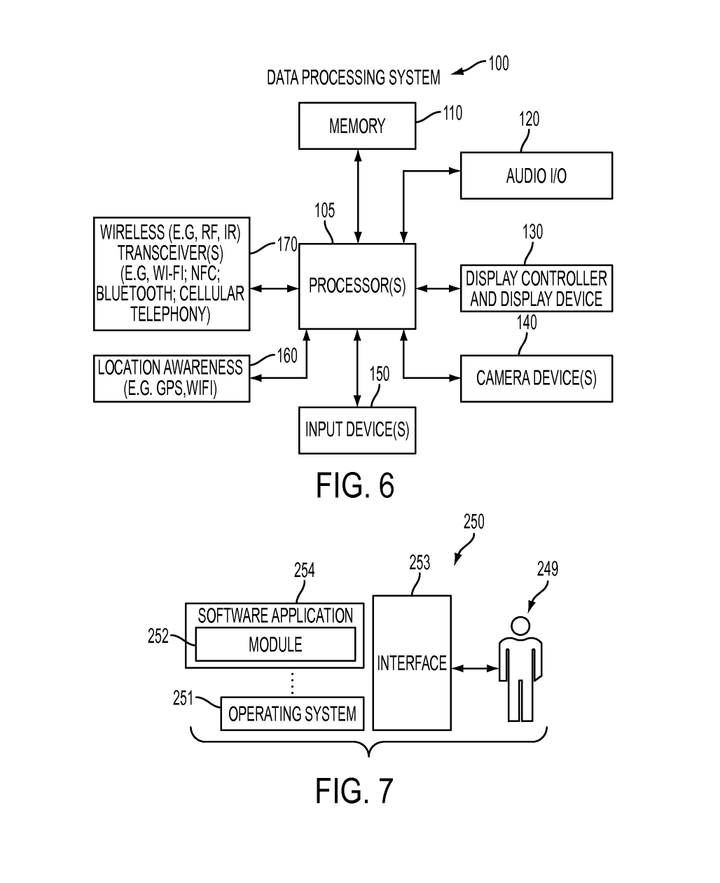

FIG. 6 illustrates a block diagram of an example mobile data processing system 100 on which applications implement the disclosed method/system. The data processing system 100 can include, for example, a processor 105, which in some embodiments, may be composed of one or more microprocessors. The system 100 also can include a memory 110 for storing data and programs for execution by the processing system. The system 100 additionally includes an audio input/output subsystem 120 which may include a microphone and a speaker for playing back music or providing telephone functionality through the speaker and microphone. Data-processing system 100 is an example of, for example, system 40 as discussed earlier.

A display controller and display device 130 can be used to provide a graphical user interface for the user, such as the graphics user interface provided by mobile devices such as, for example., an Android-based mobile device, the iPhone, iPad, etc. Additionally, the display and audio functionality can be coupled to provide video playback or video communication services. A wireless transceiver 170 can transmit and receive data via one or more wireless technologies such as Near Field Communication (NFC), Wi-Fi, infrared, Bluetooth, or one or more variants of wireless cellular technology.

One embodiment of system 100 can contain one or more camera devices 140 configured in both a front and rear facing configuration, though similarly configured systems each with a front facing camera, or no camera, can be one of many optimal configurations. The data processing system 100 can also include one or more input devices 150 that allow a user to provide input to the system. Input devices can include a keypad or keyboard, alone or in conjunction with a voice recognition system, or a touch or multi-touch panel that is overlaid on the display device 130. Additionally, embodiments of the data processing system 100 can also include a device for providing location awareness services, such as a Global Positioning System (GPS) device 160 or its equivalent. Note that that GPS device 160 is similar or analogous to the GPS modules 52 and/or 53 shown in FIG. 4. Modules 52 and/or 53 can implemented as physical hardware modules and/or software modules, depending upon design considerations.

It is to be noted that the data processing system 100 as represented in FIG. 6 is by way of example. One or more buses or interfaces, which are not shown, can be used to interconnect the various components, as is well known in the art. As well, additional components, not shown, may also be part of the system 100 in certain embodiments, and in certain embodiments, fewer or more components than those shown in FIG. 6 and/or FIG. 7 may also be used.

FIG. 7 illustrates a computer software system 250 for directing the operation of the data-processing system 100 depicted in FIG. 6. Software application 254 can be stored in, for example, memory 110 and/or on a server such as, for example, a remote server that communicates with the data-processing system 100. Software application 254 can generally include a kernel or operating system 251 and a shell or interface 253. One or more application programs, such as software application 254, may be “loaded” (i.e., transferred from the memory 110 and/or, for example, a server for execution by the data-processing system 100. The data-processing system 100 can receive user commands and data through, for example, the user interface 253; these inputs may then be acted upon by the data-processing system 100 in accordance with instructions from operating system 251 and/or software application 254 typically embodied in a module such as module 252.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application. An example of a “module” is module 252 shown in FIG. 7, which may be in some embodiments, a mobile “app”. In other embodiments, the module 252 may comprise an app that runs on a mobile electronic device and/or associated software running on a server and which communicates with, for example, system 40 shown in FIG. 4.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

The interface 253, which is preferably a graphical user interface (GUI), also serves to display results, whereupon the user may supply additional inputs or terminate the session. In some embodiment, operating system 251 and interface 253 can be implemented in the context of a single OS or with multiple different OS types (e.g., Android, Apple, Windows, Mac, Linux, etc.). Software application 254 can include instructions for carrying out, for example, steps or logical operations such as those shown in FIG. 5 along with various other operations and aspects described herein.

FIGS. 6-7 are intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software.

Based on the foregoing, it can be appreciated that a number of embodiments are disclosed herein, preferred and alternative. For example, in one embodiment a system can be implemented, which aids on-street parking occupancy detection from a moving device. Such a system can include, for example, one or more optimized routes pre-selected for scheduling a moving device from one location to another; a display device that graphically displays the optimized route(s) and a current location of the moving device with respect to the optimized route(s); and a recording device that records parking occupancy data for display via the display device for the collection and analysis of the parking occupancy data for on-street parking occupancy detection.

In some embodiments, such a system may include a GPS module that communicates with the recording device to assist in determining the location of the parking occupancy data. In another embodiment, the display device graphically displays a window that allows manual input of the parking occupancy data to the recording device. In yet other embodiments, the parking occupancy data may also be obtained by human eye surveillance. The parking occupancy data can also be obtained from one or more cameras. In addition, one location to another location may constitute one or more street blocks along the optimized route.

In still another embodiment, a memory can be implemented that communicates with the recording device and the display device, wherein the optimized route(s) is downloaded as data from a remote server to the memory. In some embodiments, the location of the moving device can be initially positioned at a first location along the optimized route(s) and the display device can display an identifying name of the first location. In another embodiment, the aforementioned parking occupancy data can include, for example, survey data automatically recorded by the recording device as the moving device moves through the optimized route(s).

In another embodiment, a system for aiding on-street parking occupancy detection from a moving device can be implemented. Such a system can include, for example, a processor and a non-transitory computer-usable medium embodying computer program code, the non-transitory computer-usable medium capable of communicating with the processor. The computer program code can include instructions executable by the processor and configured for: pre-selecting one or more optimized routes for scheduling a moving device from one location to another; graphically displaying via a display device the optimized route(s) and a current location of the moving device with respect to the optimized route(s); and recording parking occupancy data via a recording device for display via the display device for the collection and analysis of the parking occupancy data for on-street parking occupancy detection.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for aiding on-street parking occupancy detection from a moving device, said system comprising:
at least one optimized route that is pre-selected for scheduling the moving device from one location to another;
a display device that graphically displays said at least one optimized route and a current location of the moving device with respect to said at least one optimized route; and
a recording device that records parking occupancy data for display via said display device and for the collection and analysis of said parking occupancy data for on-street parking occupancy detection.

2. The system of claim 1 further comprising a GPS (Global Positioning Satellite) module that communicates with said recording device to assist in determining a location of said parking occupancy data for said on-street parking occupancy detection.

3. The system of claim 1 wherein said display device graphically displays a window that allows manual input of said parking occupancy data to said recording device.

4. The system of claim 1 wherein said parking occupancy data is obtained by human eye surveillance.

5. The system of claim 2 wherein said parking occupancy data is obtained from at least one camera that is utilized in association with said GPS module to obtain said occupancy parking data with respect to said on-street parking occupancy detection.

6. The system of claim 1 wherein said one location to another location comprises at least one street block along said at least one optimized route.

7. The system of claim 5 further comprising a memory that communicates with said recording device and said display device, wherein said at least one optimized route is downloaded as data from a remote server to said memory.

8. The system of claim 5 wherein said moving device is initially positioned at a first location along said at least one optimized route and wherein said display device displays an identifying name of said first location.

9. The system of claim 5 wherein said parking occupancy data further comprises survey data automatically recorded by said recording device as said moving device moves through said at least one optimized route.

10. A system for aiding on-street parking occupancy detection from a moving device, said method comprising:
a processor; and
a non-transitory computer-usable medium embodying computer program code, said non-transitory computer-usable medium capable of communicating with the processor, said computer program code comprising instructions executable by said processor and configured for:
pre-selecting at least one optimized route for scheduling the moving device from one location to another;
graphically displaying via a display device said at least one optimized route and a current location of the moving device with respect to said at least one optimized route; and
recording parking occupancy data via a recording device for display via said display device and for the collection and analysis of said parking occupancy data for on-street parking occupancy detection.

11. The system of claim 10 further comprising a GPS (Global Positioning Satellite) module that communicates with said recording device to assist in determining a location of said parking occupancy data for said on-street parking occupancy detection.

12. The system of claim 11 wherein said display device graphically displays a window that allows manual input of said parking occupancy data to said recording device.

13. The system of claim 11 further comprising a memory that communicates with said recording device and said display device, wherein said at least one optimized route is downloaded as data from a remote server to said memory and wherein said parking occupancy data is obtained from at least one camera that is utilized in association with said GPS module to obtain said occupancy parking data with respect to said on-street parking occupancy detection.

14. The system of claim 13 wherein said moving device is initially positioned at a first location along said at least one optimized route and wherein said display device displays an identifying name of said first location.

15. The system of claim 13 wherein said parking occupancy data further comprises survey data automatically recorded by said recording device as said moving device moves through said at least one optimized route.

16. A method for aiding on-street parking occupancy detection from a moving device, said method comprising:
pre-selecting at least one optimized route for scheduling the moving device from one location to another;
graphically displaying via a display device said at least one optimized route and a current location of the moving device with respect to said at least one optimized route; and
recording parking occupancy data via a recording device for display via said display device and for the collection and analysis of said parking occupancy data for on-street parking occupancy detection.

17. The method of claim 16 further comprising electronically communicating between a GPS (Global Positioning Satellite) module and said recording device to assist in determining a location of said parking occupancy data for on-street parking occupancy detection and wherein said parking occupancy data is obtained from at least one camera that is utilized in association with said GPS module to obtain said occupancy parking data with respect to said on-street parking occupancy detection.

18. The method of claim 17 wherein said display device graphically displays a window that allows manual input of said parking occupancy data to said recording device and wherein said one location to another location comprises at least one street block along said at least one optimized route.

19. The method of claim 17 further comprising storing in a memory that communicates with said recording device and said display device, said at least one optimized route which is downloadable from a remote server to said memory.

20. The method of claim 17 wherein:
said moving device is initially positioned at a first location along said at least one optimized route and wherein said display device displays an identifying name of said first location; and
said parking occupancy data comprises survey data automatically recorded by said recording device as said moving device moves through said at least one optimized route.
